(19) United States
(12) Patent Application Publication
(10) Pub. No.: US 2026/0197741 A1
(43) Pub. Date: Jul. 9, 2026

(54) METHODS AND APPARATUSES FOR A CHO WITH CANDIDATE SCG MECHANISM

(71) Applicant: Lenovo (Beijing) Limited, Beijing (CN)

(72) Inventors: Lianhai Wu, Beijing (CN); Mingzeng Dai, Shanghai (CN); Congchi Zhang, Shanghai (CN); Le Yan, Shanghai (CN)

(73) Assignee: Lenovo (Beijing) Limited, Beijing (CN)

(21) Appl. No.: 19/134,272

(22) PCT Filed: Jan. 19, 2023
(86) PCT No.: PCT/CN2023/073250

§ 371 Date: May 30, 2025

(51) Int. Cl. H04W 36/36; H04W 36/00

(52) U.S. Cl. CPC H04W 36/362; H04W 36/0077

(57) ABSTRACT

Embodiments of the present application relate to methods and apparatuses for a conditional handover (CHO) with candidate secondary cell group (SCG) mechanism. According to an embodiment of the present application, a user equipment (UE) includes a transceiver and a processor coupled to the transceiver; and the processor is configured to: receive, via the transceiver, a radio resource control (RRC) configuration and another RRC configuration, wherein the RRC configuration includes conditional handover (CHO) configuration information and a CHO execution condition for a candidate master cell group (MCG), and the another RRC configuration includes configuration information for one or more candidate secondary cell groups (SCG) sand a set of execution conditions for the one or more candidate SCGs; and evaluate the CHO execution condition for the candidate MCG upon reception of the RRC configuration.

### TECHNICAL FIELD

Embodiments of the present application generally relate to wireless communication technology, especially to methods and apparatuses for a conditional handover (CHO) with candidate secondary cell group (SCG) mechanism.

### BACKGROUND

A CHO is defined as a handover that is executed by a user equipment (UE) when one or more handover execution conditions are fulfilled. A user equipment (UE) starts evaluating the one or more handover execution conditions upon receiving the one or more CHO configurations and one or more CHO execution conditions, and stops evaluating the one or more CHO execution conditions during the CHO execution once the one or more CHO execution conditions are fulfilled.

Next generation radio access network (NG-RAN) supports a multi-radio dual connectivity (MR-DC) scenario. In a MR-DC scenario, a UE with multiple transceivers may be configured to utilize resources provided by two different nodes connected via non-ideal backhauls. Wherein one node may provide new radio (NR) access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, a Xn interface as specified in 3rd Generation Partnership Project (3GPP) standard documents), and at least the MN is connected to the core network. Currently, details regarding a CHO with candidate SCG mechanism in an MR-DC scenario have not been discussed yet.

### SUMMARY

Some embodiments of the present application provide a user equipment (UE). The UE includes a transceiver and a processor coupled to the transceiver; and the processor is configured to: receive, via the transceiver, a first radio resource control (RRC) configuration and a second RRC configuration, wherein the first RRC configuration includes conditional handover (CHO) configuration information and a CHO execution condition for a candidate master cell group (MCG), and the second RRC configuration includes configuration information for one or more candidate secondary cell groups (SCG) s and a set of execution conditions for the one or more candidate SCGs; and evaluate the CHO execution condition for the candidate MCG upon reception of the first RRC configuration.

In some embodiments, the first RRC configuration and the second RRC configuration are received via separate messages or via a same message.

In some embodiments, the configuration information for the one or more candidate SCGs and the set of execution conditions for the one or more candidate SCGs include: conditional primary secondary cell group (PSCell) addition (CPA) configuration information and a set of CPA execution conditions for the one or more candidate SCGs; or conditional PSCell change (CPC) configuration information and a set of CPC execution conditions for the one or more candidate SCGs.

In some embodiments, the processor of the UE is further configured to: evaluate the set of CPA execution conditions upon reception of the second RRC configuration for CPA; or evaluate the set of CPC execution conditions upon reception of the second RRC configuration for CPC.

In some embodiments, the processor of the UE is further configured to: start to evaluate the set of CPA execution conditions in response to fulfillment of the CHO execution condition for the candidate MCG; or start to evaluate the set of CPC execution conditions in response to the fulfillment of the CHO execution condition for the candidate MCG.

In some embodiments, the processor of the UE is further configured to: stop evaluating the set of CPA execution conditions for other one or more candidate SCGs within the one or more candidate SCGs in response to fulfillment of the set of CPA execution condition for one candidate SCG within the one or more candidate SCGs; or stop evaluating the set of CPC execution conditions for other one or more candidate SCGs within the one or more candidate SCGs in response to fulfillment of the set of CPC execution conditions for one candidate SCG within the one or more candidate SCGs.

In some embodiments, the processor of the UE is configured to release the second RRC configuration in response to that: the set of execution conditions for each candidate SCG within the one or more candidate SCGs is not fulfilled when the UE completes a random access (RA) procedure to the candidate MCG; the set of execution conditions for the each candidate SCG is not fulfilled when a handover timer for the candidate MCG is stopped; the set of execution conditions for the each candidate SCG is not fulfilled after a first time period since the UE completes the RA procedure to the candidate MCG; the set of execution conditions for the each candidate SCG is not fulfilled when the CHO execution condition for the candidate MCG is fulfilled; or the set of execution conditions for the each candidate SCG is not fulfilled after a second time period since fulfillment of the CHO execution condition for the candidate MCG.

In some embodiments, in response to fulfillment of the CHO execution condition for the candidate MCG, the processor of the UE is further configured to stop evaluating the set of execution conditions for the one or more candidate SCGs in response to that: the set of execution conditions for each candidate SCG within the one or more candidate SCGs is not fulfilled when the UE completes a random access (RA) procedure to the candidate MCG; the set of execution conditions for the each candidate SCG is not fulfilled when a handover timer for the candidate MCG is stopped; the set of execution conditions for the each candidate SCG is not fulfilled after a first time period since the UE completes the RA procedure to the candidate MCG; the set of execution conditions for the each candidate SCG is not fulfilled when the CHO execution condition for the candidate MCG is fulfilled; or the set of execution conditions for the each candidate SCG is not fulfilled after a second time period since the fulfillment of the CHO execution condition for the candidate MCG.

In some embodiments, the processor of the UE is further configured to release the set of execution conditions for the candidate SCG(s) after stopping evaluating the set of execution conditions for the candidate SCG(s).

In some embodiments, in response to fulfillment of the CHO execution condition for the candidate MCG, the processor of the UE is configured to: perform a random access (RA) procedure to the candidate MCG based on the first RRC configuration; and transmit an RRC reconfiguration complete message to a candidate MN associated with the candidate MCG.

In some embodiments, the processor of the UE is configured to: in response to that the set of CPA execution conditions for one candidate SCG within the one or more SCGs is fulfilled and the UE completes the RA procedure to the candidate MCG, transmit, via the transceiver to a candidate MN associated with the candidate MCG, a first indication indicating that the one candidate SCG is selected for cell addition; or in response to that the set of CPC execution conditions for the one candidate SCG is fulfilled and the UE completes the RA procedure to the candidate MCG, transmit, via the transceiver to the candidate MN, a second indication indicating that the one candidate SCG is selected for cell switching.

In some embodiments, the processor of the UE is configured to: in response to that the set of CPA execution conditions for each candidate SCG within the one or more candidate SCGs is not fulfilled and the UE completes the RA procedure to the candidate MCG, transmit, via the transceiver to a candidate MN associated with the candidate MCG, a third indication indicating that no candidate SCG within the one or more SCGs is selected for cell addition; or in response to that the set of CPC execution conditions for the each candidate SCG is not fulfilled and the UE completes the RA procedure to the candidate MCG, transmit, via the transceiver to the candidate MN, a fourth indication indicating that no candidate SCG within the one or more SCGs is selected for cell switching.

In some embodiments, in response to that the UE fails to perform a CHO procedure to the candidate MCG, the processor of the UE is configured to perform a CHO recovery procedure to the candidate MCG.

In some embodiments, the processor of the UE is further configured to transmit, via the transceiver to a candidate MN associated with the candidate MCG, a fifth indication indicating that a procedure to no candidate SCG is allowed to be performed during the CHO recovery procedure.

In some embodiments, at least one of the first indication, the second indication, the third indication, the fourth indication or the fifth indication is included in a SN RRC reconfiguration complete message embodied in an RRC reconfiguration complete message to the candidate MN.

In some embodiments, in response to that the SN RRC reconfiguration complete message includes at least one of the first indication or the second indication, the SN RRC reconfiguration complete message further includes an identity (ID) of the one candidate SCG.

In some embodiments, in response to completing the CHO recovery procedure, the processor of the UE is configured to transmit, via the transceiver to the candidate MN, an indication indicating at least one of the following: the CHO recovery procedure; or the second RRC configuration for the one or more candidate SCGs is released due to the CHO recovery procedure.

In some embodiments, in response to fulfillment of the CHO execution condition for the candidate MCG, the processor of the UE is configured to consider the set of CPA execution conditions or the set of CPC execution conditions for a candidate SCG within the one or more candidate SCGs as fulfilled in response to: once an entering condition for the candidate SCG is fulfilled when a handover timer for the candidate MCG is running; or channel quality of a primary secondary cell (PSCell) of the candidate SCG is greater than or equal to a threshold when the handover timer is running.

In some embodiments, the processor of the UE is configured to receive an information element (IE) via the transceiver from a source MN, and the IE indicates that a CHO recovery procedure to the candidate MCG is allowed to be performed and that a CPA procedure or a CPC procedure to one or more candidate SCGs is allowed to be performed during the CHO recovery procedure for the candidate MCG.

In some embodiments, the IE is an attempt conditional reconfiguration IE included in the second RRC configuration.

In some embodiments, in response to that the CPA procedure or the CPC procedure to the one or more candidate SCGs is allowed to be performed, the processor of the UE is configured to perform the CPA procedure or the CPC procedure to a candidate SCG within the one or more candidate SCGs during a CHO recovery procedure to the candidate MCG in response to that channel quality of a primary secondary cell (PSCell) of the candidate SCG is greater than or equal to a threshold.

Some embodiments of the present application also provide a candidate master node (MN). The candidate MN includes a transceiver and a processor coupled to the transceiver; and the processor of the UE is configured to: receive a radio resource control (RRC) reconfiguration complete message via the transceiver from a user equipment (UE); and transmit an indication associated with a candidate secondary cell group (SCG) via the transceiver to a candidate SN.

In some embodiments, the indication indicates at least one of the following: the candidate SCG is selected for cell addition; the candidate SCG is selected for cell switching; the candidate SCG is not selected for cell addition; the candidate SCG is not selected for cell switching; no candidate SCG is selected for cell addition; no candidate SCG is selected for cell switching; a conditional primary secondary cell group (PSCell) addition (CPA) procedure to no candidate SCGs is allowed to be performed during a conditional handover (CHO) recovery procedure to a candidate master cell group (MCG); a conditional PSCell change (CPC) procedure to no candidate SCG is allowed to be performed during the CHO recovery procedure; a user equipment (UE) accesses the candidate MCG via a CHO procedure; the UE accesses the candidate MCG via the CHO recovery procedure; or an RRC configuration for the candidate SCG is released by the UE due to the CHO recovery procedure.

In some embodiments, the indication associated with the candidate SCG is carried in a SN RRC reconfiguration complete message.

In some embodiments, the SN RRC reconfiguration complete message is included in the RRC reconfiguration complete message, and includes an identity (ID) of the candidate SCG belonging to the candidate SN.

In some embodiments, the processor of the candidate MN is configured to: receive the indication via the transceiver from the UE; or generate the indication based on the RRC reconfiguration complete message.

In some embodiments, the processor of the candidate MN is further configured to: transmit an information element (IE) via the transceiver to the UE, and the IE indicates that a CHO recovery procedure to the candidate MCG is allowed to be performed and that a CPA procedure or a CPC procedure to one or more candidate SCGs is allowed to be performed during the CHO recovery procedure.

In some embodiments, the IE is an attempt conditional reconfiguration IE included in a RRC configuration.

In some embodiments, the processor of the candidate MN is configured to transmit, via the transceiver to a source MN, an RRC configuration including conditional handover (CHO) configuration information and a CHO execution condition for a candidate master cell group (MCG).

Some embodiments of the present application also provide a candidate secondary node (SN). The candidate SN includes a transceiver and a processor coupled to the transceiver; and the processor is configured to: transmit, via the transceiver to a candidate master node (MN), a radio resource control (RRC) configuration including configuration information for one or more candidate secondary cell groups (SCG) s and a set of execution conditions for the one or more candidate SCGs; and receive an indication associated with the one or more candidate SCGs via the transceiver from the candidate MN.

In some embodiments, the configuration information for the one or more candidate SCGs and the set of execution conditions for the one or more candidate SCGs include: conditional primary secondary cell group (PSCell) addition (CPA) configuration information and a set of CPA execution conditions for the one or more candidate SCGs; or conditional PSCell change (CPC) configuration information and a set of CPC execution conditions for the one or more candidate SCGs.

In some embodiments, the indication indicates at least one of: the candidate SCG is selected for cell addition; the candidate SCG is selected for cell switching; the candidate SCG is not selected for cell addition; the candidate SCG is not selected for cell switching; no candidate SCG is selected for cell addition; no candidate SCG is selected for cell switching; a conditional primary secondary cell group (PSCell) addition (CPA) procedure to no candidate SCGs is allowed to be performed during a conditional handover (CHO) recovery procedure to a candidate master cell group (MCG); a conditional PSCell change (CPC) procedure to no candidate SCG is allowed to be performed during the CHO recovery procedure; a user equipment (UE) accesses the candidate MCG via a CHO procedure; the UE accesses the candidate MCG via the CHO recovery procedure; or an RRC configuration for the candidate SCG is released by the UE due to the CHO recovery procedure.

In some embodiments, the processor of the candidate SN is further configured to release resources for the candidate SCG in response to the indication indicating that: the candidate SCG is not selected for cell addition; the candidate SCG is not selected for cell switching; no candidate SCG is selected for cell addition; or no candidate SCG is selected for cell switching.

Some embodiments of the present application provide a method performed by a UE. The method includes: receiving a first radio resource control (RRC) configuration and a second RRC configuration, wherein the first RRC configuration includes conditional handover (CHO) configuration information and a CHO execution condition for a candidate master cell group (MCG), and the second RRC configuration includes configuration information for one or more candidate secondary cell groups (SCG) s and a set of execution conditions for the one or more candidate SCGs; and evaluating the CHO execution condition for the candidate MCG upon reception of the first RRC configuration.

Some embodiments of the present application provide a method performed by a candidate MN. The method includes: receiving a radio resource control (RRC) reconfiguration complete message from a user equipment (UE); and transmitting an indication associated with a candidate secondary cell group (SCG) to a candidate SN.

Some embodiments of the present application provide a method performed by a candidate SN. The method includes: transmitting, to a candidate master node (MN), a radio resource control (RRC) configuration including configuration information for one or more candidate secondary cell groups (SCG) s and a set of execution conditions for the one or more candidate SCGs; and receiving an indication associated with the one or more candidate SCGs from the candidate MN.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE or a network node (a source MN, a target MN, a candidate MN, a source SN, a target SN, or a candidate SN).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary flowchart of a CHO with candidate SCG mechanism in accordance with some embodiments of the present application.

FIG. 3 illustrates an exemplary flowchart of transmitting an indication associated with a candidate SCG in accordance with some embodiments of the present application.

FIG. 4 illustrates an exemplary flowchart of receiving an indication associated with a candidate SCG in accordance with some embodiments of the present application.

FIGS. 5-8 illustrate exemplary flowcharts of a CHO with candidate SCG mechanism in accordance with some embodiments of the present application.

FIG. 9 illustrates a block diagram of an exemplary apparatus in accordance with some embodiments of the present disclosure.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents for NR-NR DC or NGEN-DC or NE-DC, or X2 interface as specified in 3GPP standard documents for EN-DC. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary secondary cell (PSCell) and optionally one or more secondary cells (SCells). The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g. televisions connected to the Internet), set-top boxes, game consoles, security systems (including security cameras), vehicle on-board computers, network devices (e.g. routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In general, a CHO is executed by a UE when one or more handover execution conditions are fulfilled. A UE starts evaluating the execution condition(s) upon receiving the CHO configuration, and stops evaluating the execution condition during the CHO execution once the execution condition(s) is fulfilled. A CHO configuration contains the configuration for CHO candidate cell(s) generated by the candidate BS(s) and execution condition(s) generated by a source BS.

As in an intra-NR RAN handover, or in intra-NR radio access network (RAN) CHO, the preparation and execution phase of the CHO procedure is performed without involvement of the 5G Core Network (5GC); i.e., preparation messages are directly exchanged between BSs. The release of the resources at the source BS during the conditional handover completion phase is triggered by a candidate BS, wherein neither the access and mobility management function (AMF) nor the user plane function UPF changes.

In general, an inter-MN handover with or without MN initiated SN change is used to transfer UE context data from a source MN to a candidate MN while the UE context at the SN is kept or moved to another SN. During an Inter-MN handover, the candidate MN decides whether to keep or change the SN (or release the SN). Only intra radio access technology (intra-RAT) Inter-MN handover with or without SN change is supported.

Currently, there is no mechanism for the case of CHO with one or more candidate SCGs. Embodiments of the present disclosure aim to solve such issue. In particular, some embodiments of the present disclosure design a mechanism to support that both CHO and candidate SCG(s) can be performed simultaneously. In some embodiments of the present disclosure, addition information is (e.g. included in an RRC reconfiguration complete message) transmitted to a candidate node or a target node after a UE performs CHO with or without a candidate SCG within one or more candidate SCGs. Some embodiments of the present disclosure design the relaxed execution condition(s) for candidate SCG(s) when CHO execution condition(s) is fulfilled. Some embodiments of the present disclosure introduce an enhanced mechanism for a CHO recovery in the case of CHO with candidate SCG(s).

In some embodiments of the present disclosure, during cell switching (e.g. a CHO procedure) from a source SN, a candidate MN may also be named as a target MN or a target candidate MN or the like. During cell addition or cell switching (e.g. a CPA or CPC procedure), a candidate SN may also be named as a target SN or a target candidate SN or the like. During cell addition or cell switching, a candidate cell may also be named as a target cell or a target candidate cell or the like. In other words, from a UE's perspective, the same MN may be named as a candidate MN or a target MN in different scenarios, the same SN may be named as a candidate SN or a target SN in different scenarios, and the same cell may be named as a candidate cell or a target cell in different scenarios, without departing from the spirit and scope of the disclosure.

More details regarding the embodiments of the present application will be illustrated in the following text in combination with the appended drawings.

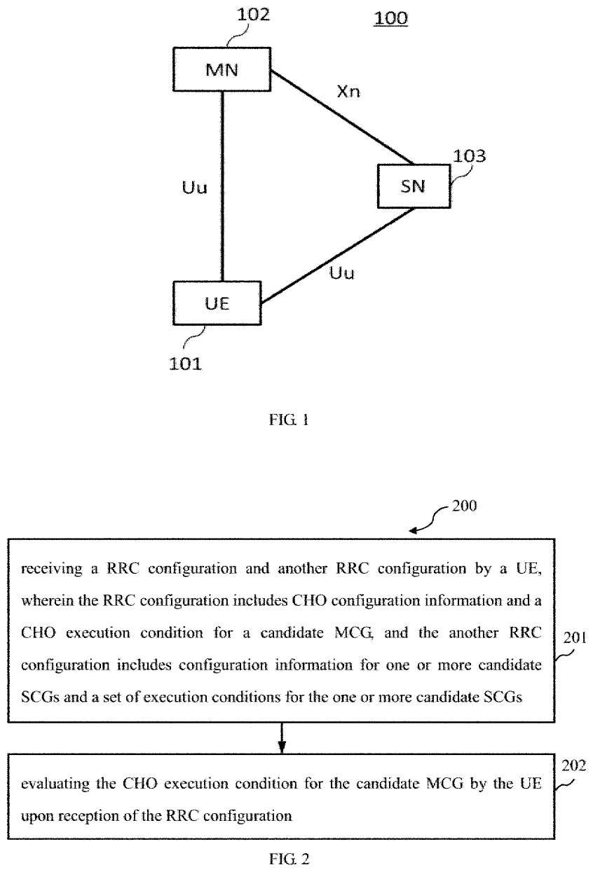

FIG. 2 illustrates an exemplary flowchart of a CHO with candidate SCG mechanism in accordance with some embodiments of the present application. The exemplary procedure 200 in the embodiments of FIG. 2 may be performed by a UE, e.g. UE 101, UE 701, UE 801, UE 901, or UE 1001 as shown in any of FIGS. 1 and 5-8. Although described with respect to a UE, it should be understood that other devices may be configured to perform a method similar to that of FIG. 2.

In the exemplary procedure 200 as shown in FIG. 2, in operation 201, a UE may receive an RRC configuration (denoted as RRC configuration #1 for simplicity) and another RRC configuration (denoted as RRC configuration #2). RRC configuration #1 includes CHO configuration information and a CHO execution condition for a candidate MCG. The CHO execution condition for the candidate MCG may include one or more execution conditions for the candidate MCG, e.g. entering conditions and/or leaving conditions. RRC configuration #2 includes configuration information for one or more candidate SCGs and a set of execution conditions for the one or more candidate SCGs.

RRC configuration #1 and RRC configuration #2 may be received via separate messages or via a same message. For instance, a candidate MN (e.g. candidate MN 705) may generate configuration(s) for its corresponding candidate MCG and transmit the configuration(s) for the corresponding candidate MCG (i.e. RRC configuration #1) to a source MN (e.g. source MN 702). A candidate SN (e.g. candidate SN 704) of the candidate MN may generate configuration(s) for its corresponding candidate SCG(s) and transmit the configuration(s) for the corresponding candidate SCG(s) to the candidate MN. The candidate MN may transfer configuration(s) for all candidate SCG(s) (i.e. RRC configuration #2), which are received from one or more candidate SNs, to the source MN. Then, in some embodiments, the source MN may transmit one RRC reconfiguration message including both RRC configuration #1 and RRC configuration #2 to the UE (e.g. UE 701). In some other embodiments, the source MN may transmit one RRC reconfiguration message including RRC configuration #1 and transmit another RRC reconfiguration message including RRC configuration #2 to the UE.

In operation 202, the UE may evaluate the CHO execution condition for the candidate MCG upon reception of RRC configuration #1.

In some embodiments, the set of execution conditions for the one or more candidate SCGs in RRC configuration #2 may be conditional PSCell addition or change (CPAC) execution condition(s) for the one or more candidate SCGs. In some embodiments, in RRC configuration #2, the configuration information for the one or more candidate SCGs and the set of execution conditions for the one or more candidate SCGs include:
(1) CPA configuration information and a set of CPA execution conditions for the one or more candidate SCGs; or
(2) CPC configuration information and a set of CPC execution conditions for the one or more candidate SCGs.

In some embodiments, the UE may concurrently evaluate the CHO execution condition for the candidate MCG and evaluate the set of CPA or CPC execution conditions for candidate SCG(s). In an embodiment, the UE may evaluate the set of CPA execution conditions upon reception of RRC configuration #2 for CPA. In another embodiment, the UE may evaluate the set of CPC execution conditions upon reception of RRC configuration #2 for CPC.

In some other embodiments, the UE may sequentially evaluate the CHO execution condition for the candidate MCG and evaluate the set of CPA or CPC execution conditions for candidate SCG(s). For some cases, the UE may firstly evaluate the CHO execution condition for the candidate MCG, and then start to evaluate the set of CPA or CPC execution conditions for candidate SCG(s) after the CHO execution condition for the candidate MCG is fulfilled. In an embodiment, the UE starts to evaluate the set of CPA execution conditions in response to fulfillment of the CHO execution condition for the candidate MCG. In another embodiment, the UE starts to evaluate the set of CPC execution conditions in response to fulfillment of the CHO execution condition for the candidate MCG.

For some other cases, the UE may firstly evaluate the set of CPA or CPC execution conditions for candidate SCG(s), and then start to evaluate the CHO execution condition for the candidate MCG after the set of CPA or CPC execution conditions for candidate SCG(s) is fulfilled. In such cases, CHO with candidate SCG(s) is performed only if execution conditions for the candidate MCG and the candidate SCG(s) are fulfilled together. CHO with candidate SCG(s) is not applied if only the CHO execution condition for the candidate MCG is fulfilled but the set of CPA or CPC execution conditions for candidate SCG(s) candidate SCG is not met. A specific example is described in Embodiment 3 of the embodiments of FIG. 5 as below.

In some embodiments, if the set of CPA execution condition for one candidate SCG (denoted as candidate SCG #1) within the candidate SCG(s) is fulfilled, the UE may stop evaluating the set of CPA execution conditions for other candidate SCG(s) within the candidate SCG(s). In some other embodiments, if the set of CPC execution conditions for one candidate SCG (e.g. candidate SCG #1) within the candidate SCG(s) is fulfilled, the UE may stop evaluating the set of CPC execution conditions for other candidate SCG(s) within the candidate SCG(s). A specific example is described in Embodiment 2 of the embodiments of FIG. 5 as below.

In some embodiments, when the UE “concurrently evaluate” or “sequentially evaluate” the CHO execution condition for the candidate MCG and the set of CPA or CPC execution conditions for candidate SCG(s) as described above, the UE may release RRC configuration #2 in response to that:
(1) the set of execution conditions for each candidate SCG within the candidate SCG(s) is not fulfilled when the UE completes an RA procedure to the candidate MCG;
(2) the set of execution conditions for the each candidate SCG is not fulfilled when a handover timer (e.g. timer T304 as described in 3GPP standard documents) for the candidate MCG is stopped;
(3) the set of execution conditions for the each candidate SCG is not fulfilled after a time period (denoted as time period #1) since the UE completes the RA procedure to the candidate MCG;
(4) the set of execution conditions for the each candidate SCG is not fulfilled when the CHO execution condition for the candidate MCG is fulfilled; or
(5) the set of execution conditions for the each candidate SCG is not fulfilled after a time period (denoted as time period #2) since fulfillment of the CHO execution condition for the candidate MCG.

In an embodiment, the UE may release RRC configuration #2 in response to that:
(1) the set of CPA execution conditions for each candidate SCG within the one or more candidate SCGs is not fulfilled when the UE completes a random access (RA) procedure to the candidate MCG;
(2) the set of CPA execution conditions for the each candidate SCG is not fulfilled when a handover timer (e.g. timer T304) for the candidate MCG is stopped;
(3) the set of CPA execution conditions for the each candidate SCG is not fulfilled after time period #1;
(4) the set of CPA execution conditions for the each candidate SCG is not fulfilled when the CHO execution condition for the candidate MCG is fulfilled; or
(5) the set of CPA execution conditions for the each candidate SCG is not fulfilled after time period #2.

In another embodiment, the UE may release RRC configuration #2 in response to that:
(1) the set of CPC execution conditions for the each candidate SCG is not fulfilled when the UE completes a RA procedure to the candidate MCG;
(2) the set of CPC execution conditions for the each candidate SCG is not fulfilled when a handover timer (e.g. timer T304) for the candidate MCG is stopped;
(3) the set of CPC execution conditions for the each candidate SCG is not fulfilled after time period #1;
(4) the set of CPC execution conditions for the each candidate SCG is not fulfilled when the CHO execution condition for the candidate MCG is fulfilled; or
(5) the set of CPC execution conditions for the each candidate SCG is not fulfilled after time period #2.

In some embodiments, if the CHO execution condition for the candidate MCG is fulfilled, the UE may stop evaluating the set of execution conditions for the candidate SCG(s) in response to that:
(1) the set of execution conditions for each candidate SCG within the candidate SCG(s) is not fulfilled when the UE completes a RA procedure to the candidate MCG;
(2) the set of execution conditions for the each candidate SCG is not fulfilled when a handover timer (e.g. timer T304) for the candidate MCG is stopped;
(3) the set of execution conditions for the each candidate SCG is not fulfilled after time period #1;
(4) the set of execution conditions for the each candidate SCG is not fulfilled when the CHO execution condition for the candidate MCG is fulfilled; or
(5) the set of execution conditions for the each candidate SCG is not fulfilled after time period #2.

In an embodiment, if the CHO execution condition for the candidate MCG is fulfilled, the UE may stop evaluating the set of CPA execution conditions for the candidate SCG(s) in response to that:
(1) the set of CPA execution conditions for each candidate SCG within the candidate SCG(s) is not fulfilled when the UE completes a RA procedure to the candidate MCG;
(2) the set of CPA execution conditions for the each candidate SCG is not fulfilled when a handover timer (e.g. timer T304) for the candidate MCG is stopped;
(3) the set of CPA execution conditions for the each candidate SCG is not fulfilled after time period #1;
(4) the set of CPA execution conditions for the each candidate SCG is not fulfilled when the CHO execution condition for the candidate MCG is fulfilled; or
(5) the set of CPA execution conditions for the each candidate SCG is not fulfilled after time period #2.

In another embodiment, if the CHO execution condition for the candidate MCG is fulfilled, the UE may stop evaluating the set of CPC execution conditions for the candidate SCG(s) in response to that:
(1) the set of CPC execution conditions for each candidate SCG within the candidate SCG(s) is not fulfilled when the UE completes a RA procedure to the candidate MCG;
(2) the set of CPC execution conditions for the each candidate SCG is not fulfilled when a handover timer (e.g. timer T304) for the candidate MCG is stopped;
(3) the set of CPC execution conditions for the each candidate SCG is not fulfilled after time period #1;
(4) the set of CPC execution conditions for the each candidate SCG is not fulfilled when the CHO execution condition for the candidate MCG is fulfilled; or
(5) the set of CPC execution conditions for the each candidate SCG is not fulfilled after time period #2.

In some embodiments, the UE may release the set of execution conditions for the candidate SCG(s) after stopping evaluating the set of execution conditions for the candidate SCG(s). A specific example is described in Embodiment 1 of the embodiments of FIG. 5 as below.

In some embodiments, if the CHO execution condition for the candidate MCG is fulfilled, the UE may perform a RA procedure to the candidate MCG based on the first RRC configuration; and transmit an RRC reconfiguration complete message to a candidate MN associated with the candidate MCG.

In some embodiments, if the set of CPA execution conditions for one candidate SCG (e.g. candidate SCG #1) within the candidate SCG(s) is fulfilled and the UE completes the RA procedure to the candidate MCG, the UE may transmit an indication (denoted as indication #1), which indicates that candidate SCG #1 is selected for cell addition, to a candidate MN associated with the candidate MCG.

In some other embodiments, if the set of CPC execution conditions for one candidate SCG (e.g. candidate SCG #1) is fulfilled and the UE completes the RA procedure to the candidate MCG, the UE may transmit an indication (denoted as indication #2), which indicates that candidate SCG #1 is selected for cell switching, to the candidate MN.

In some embodiments, if the set of CPA execution conditions for a subset of candidate SCG(s) is not fulfilled and the UE completes the RA procedure to the candidate MCG, the UE may transmit an indication (denoted as indication #3), which indicates the subset of candidate SCG(s) not selected from the candidate SCG(s) for cell addition, to a candidate MN associated with the candidate MCG. For instance, indication #3 includes ID information of each SCG of the subset of candidate SCG(s).

In some other embodiments, if the set of CPC execution conditions for a subset of candidate SCG(s) is not fulfilled and the UE completes the RA procedure to the candidate MCG, the UE may transmit an indication (denoted as indication #4), which indicates the subset of candidate SCG(s) not selected from the candidate SCG(s) for cell switching, to the candidate MN. For instance, indication #4 includes ID information of each SCG of the subset of candidate SCG(s).

In some embodiments, if the set of CPA execution conditions for each candidate SCG is not fulfilled and the UE completes the RA procedure to the candidate MCG, the UE may transmit an indication (denoted as indication #5), which indicates that no candidate SCG within the candidate SCG(s) is selected for cell addition, to a candidate MN associated with the candidate MCG.

In some other embodiments, if the set of CPC execution conditions for each candidate SCG is not fulfilled and the UE completes the RA procedure to the candidate MCG, the UE may transmit an indication (denoted as indication #6), which indicates that no candidate SCG within the candidate SCG(s) is selected for cell switching, to the candidate MN.

In some embodiments, in response to that the UE fails to perform a CHO procedure to the candidate MCG, the UE may perform a CHO recovery procedure to the candidate MCG.

In some embodiments, the UE may transmit an indication (denoted as indication #7), which indicates that a procedure (e.g. a CPA procedure or a CPC procedure) to no candidate SCG is allowed to be performed during the CHO recovery procedure, to a candidate MN associated with the candidate MCG.

In some embodiments, indication #1, indication #2, indication #3, indication #4, indication #5, indication #6, and/or indication #7 is included in a SN RRC reconfiguration complete message embodied in an RRC reconfiguration complete message to the candidate MN.

In some embodiments, if the SN RRC reconfiguration complete message includes indication #1 and/or indication #2, the SN RRC reconfiguration complete message further includes an identity (ID) of the one candidate SCG (e.g. candidate SCG #1) that is associated with indication #1 or indication #2.

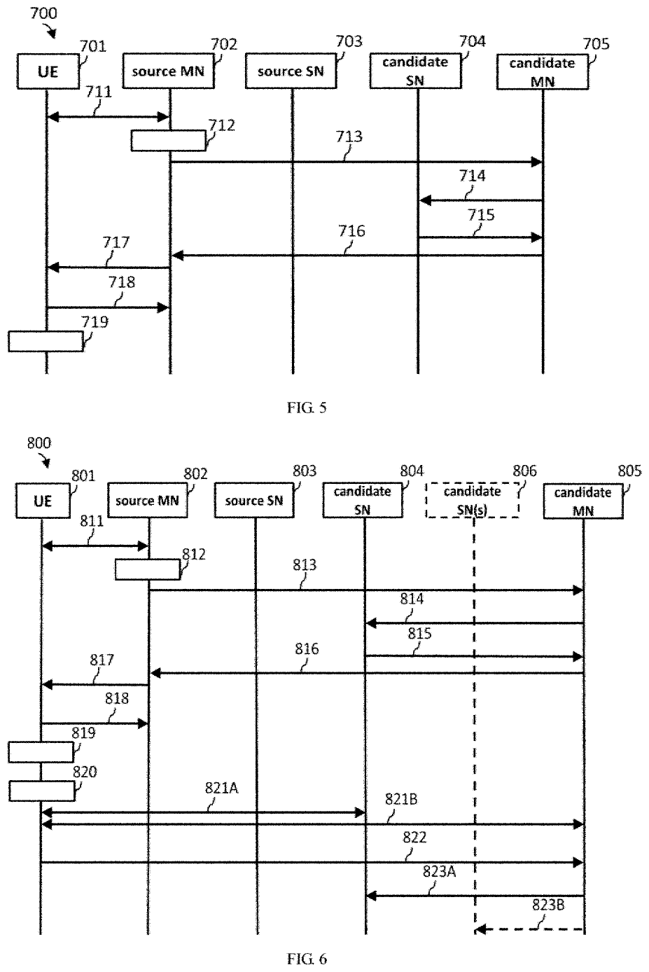

In some embodiments, in response to completing a CHO recovery procedure to the candidate MCG, the UE may transmit at least one of the following indications to the candidate MN:
(1) an indication (denoted as indication #8) indicating the CHO recovery procedure; or
(2) an indication (denoted as indication #9) indicating that RRC configuration #2 for the candidate SCG(s) is released due to the CHO recovery procedure. Specific examples are described in the embodiments of FIGS. 6-8 as below.

In some embodiments, if the CHO execution condition for the candidate MCG is fulfilled, the CPA or CPC execution conditions may be relaxed. For example, if the CHO execution condition for the candidate MCG is fulfilled, the UE may consider the set of CPA execution conditions or the set of CPC execution conditions for a candidate SCG within the candidate SCG(s) as fulfilled in response to:
(1) once an entering condition for the candidate SCG (e.g. an entering condition for CPA or CPC) is fulfilled when a handover timer (e.g. T304) for the candidate MCG is running; or
(2) channel quality of a PSCell of the candidate SCG is greater than or equal to a threshold (e.g. when S-criteria as described in 3GPP standard documents is fulfilled) when the handover timer (e.g. T304) is running.

In some embodiments, the UE may receive an information element (IE) from a source MN. The IE may indicate that a CHO recovery procedure to the candidate MCG is allowed to be performed. The IE may indicate that a CPA procedure or a CPC procedure to the candidate SCG(s) is allowed to be performed during the CHO recovery procedure for the candidate MCG. In an embodiment, the IE is an attempt conditional reconfiguration IE (e.g. attemptCondReconfig IE) included in RRC configuration #1.

In some embodiments, if the CPA procedure or the CPC procedure to the candidate SCG(s) is allowed to be performed, the UE may perform the CPA procedure or the CPC procedure to a candidate SCG within the candidate SCG(s) during a CHO recovery procedure to the candidate MCG in response to that channel quality of a PSCell of the candidate SCG is greater than or equal to a threshold (e.g. when S-criteria is fulfilled). A specific example is described in the embodiments of FIG. 8 as below.

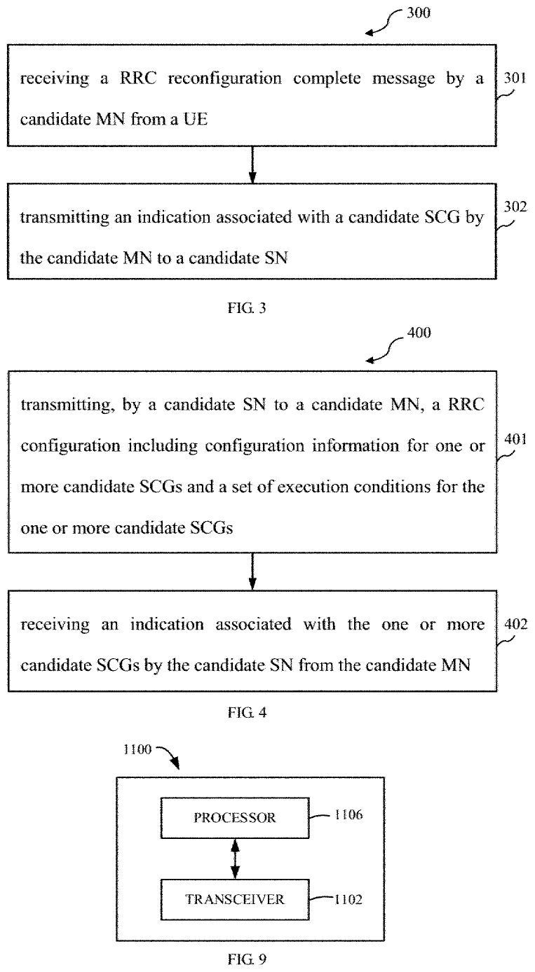

FIG. 3 illustrates an exemplary flowchart of transmitting an indication associated with a candidate SCG in accordance with some embodiments of the present application. The exemplary procedure 300 in the embodiments of FIG. 3 may be performed by a target MN or a candidate MN, e.g. MN 102, candidate MN 705, candidate MN 805, candidate MN 905, or candidate MN 1005 as shown in any of FIGS. 1 and 5-8. Although described with respect to a target MN or a candidate MN, it should be understood that other devices may be configured to perform a method similar to that of FIG. 3.

In the exemplary procedure 300 as shown in FIG. 3, in operation 301, a candidate MN may receive an RRC reconfiguration complete message from a UE (e.g. UE 101 as shown in FIG. 1). In operation 302, the candidate MN may transmit an indication associated with a candidate SCG to a candidate SN (e.g. SN 103 as shown in FIG. 1 or a candidate SN not shown in FIG. 1).

In some embodiments, the indication associated with the candidate SCG is carried in a SN RRC reconfiguration complete message. In an embodiment, the SN RRC reconfiguration complete message is included in the RRC reconfiguration complete message in operation 301. The SN RRC reconfiguration complete message may include an identity (ID) of the candidate SCG belonging to the candidate SN. In some other embodiments, the candidate MN may receive the indication from the UE. In some additional embodiments, the candidate MN may generate the indication based on the RRC reconfiguration complete message in operation 301.

In some embodiments, the indication transmitted by the candidate MN to the candidate SN in operation 302 indicates at least one of the following:
(1) the candidate SCG is selected for cell addition, e.g. indication #1 as described in the embodiments of FIG. 2;
(2) the candidate SCG is selected for cell switching, e.g. indication #2 as described in the embodiments of FIG. 2;
(3) the candidate SCG is not selected for cell addition, e.g. indication #3 as described in the embodiments of FIG. 2;
(4) the candidate SCG is not selected for cell switching, e.g. indication #4 as described in the embodiments of FIG. 2;
(5) no candidate SCG is selected for cell addition, e.g. indication #5 as described in the embodiments of FIG. 2;
(6) no candidate SCG is selected for cell switching, e.g. indication #6 as described in the embodiments of FIG. 2;
(7) a CPA procedure to no candidate SCGs is allowed to be performed during a CHO recovery procedure to a candidate MCG, e.g. indication #7 as described in the embodiments of FIG. 2;
(8) a CPC procedure to no candidate SCG is allowed to be performed during the CHO recovery procedure, e.g. indication #7 as described in the embodiments of FIG. 2; or
(9) a UE accesses the candidate MCG via a CHO procedure;
(10) the UE accesses the candidate MCG via the CHO recovery procedure, e.g. indication #8 as described in the embodiments of FIG. 2; or
(11) an RRC configuration for the candidate SCG is released by the UE due to the CHO recovery procedure, e.g. indication #9 as described in the embodiments of FIG. 2.

In some embodiments, the candidate MN may transmit an IE to the UE. The IE may indicate that a CHO recovery procedure to the candidate MCG is allowed to be performed. The IE may indicate that a CPA procedure or a CPC procedure to one or more candidate SCGs is allowed to be performed during the CHO recovery procedure. In an embodiment, the IE is an attempt conditional reconfiguration IE (e.g. attemptCondReconfig IE) included in an RRC configuration.

In some embodiments, the candidate MN may transmit, to a source MN, an RRC configuration including CHO configuration information and a CHO execution condition for a candidate MCG. For instance, the attemptCondReconfig IE is included in the RRC configuration. A specific example is described in the embodiments of FIG. 8 as below.

FIG. 4 illustrates an exemplary flowchart of receiving an indication associated with a candidate SCG in accordance with some embodiments of the present application. The exemplary procedure 400 in the embodiments of FIG. 4 may be performed by a target SN or a candidate SN, e.g. SN 103, candidate SN 704, candidate SN 804, candidate SN(s) 806, candidate SN 904, candidate SN(s) 906, candidate SN 1004, or candidate SN(s) 1006 as shown in any of FIGS. 1 and 5-8. Although described with respect to a target SN or a candidate SN, it should be understood that other devices may be configured to perform a method similar to that of FIG. 4.

In the exemplary procedure 400 as shown in FIG. 4, in operation 401, a candidate SN may transmit an RRC configuration, which includes configuration information for candidate SCG(s) and a set of execution conditions for the candidate SCG(s), to a candidate MN. In some embodiments, the set of execution conditions for the candidate SCG(s) may be CPAC execution condition(s) for the candidate SCG(s). In some embodiments, the configuration information for the candidate SCG(s) and the set of execution conditions for the candidate SCG(s) include:
(1) CPA configuration information and a set of CPA execution conditions for the candidate SCG(s); or
(2) CPC configuration information and a set of CPC execution conditions for the candidate SCG(s).

In operation 402, the candidate SN may receive an indication associated with the candidate SCG(s) from the candidate MN. In some embodiments, the indication indicates at least one of the following:
(1) the candidate SCG(s) or a subset within the candidate SCG(s) is selected for cell addition, e.g. indication #1 as described in the embodiments of FIG. 2;
(2) the candidate SCG(s) or a subset within the candidate SCG(s) is selected for cell switching, e.g. indication #2 as described in the embodiments of FIG. 2;
(3) the candidate SCG(s) is not selected for cell addition, e.g. indication #3 as described in the embodiments of FIG. 2;
(4) the candidate SCG(s) is not selected for cell switching, e.g. indication #4 as described in the embodiments of FIG. 2;
(5) no candidate SCG is selected for cell addition, e.g. indication #5 as described in the embodiments of FIG. 2;
(6) no candidate SCG is selected for cell switching, e.g. indication #6 as described in the embodiments of FIG. 2;
(7) a CPA procedure to no candidate SCGs is allowed to be performed during a CHO recovery procedure to a candidate MCG, e.g. indication #7 as described in the embodiments of FIG. 2;
(8) a CPC procedure to no candidate SCG is allowed to be performed during the CHO recovery procedure, e.g. indication #7 as described in the embodiments of FIG. 2;
(9) a UE accesses the candidate MCG via a CHO procedure;
(10) the UE accesses the candidate MCG via the CHO recovery procedure, e.g. indication #8 as described in the embodiments of FIG. 2; or
(11) an RRC configuration for the candidate SCG is released by the UE due to the CHO recovery procedure, e.g. indication #9 as described in the embodiments of FIG. 2.

In some embodiments, the candidate SN may release resources for the candidate SCG(s) in response to the indication indicating that:
(1) the candidate SCG(s) is not selected for cell addition, e.g. indication #3 as described in the embodiments of FIG. 2;
(2) the candidate SCG(s) is not selected for cell switching, e.g. indication #4 as described in the embodiments of FIG. 2;
(3) no candidate SCG is selected for cell addition, e.g. indication #5 as described in the embodiments of FIG. 2;
(4) no candidate SCG is selected for cell switching, e.g. indication #6 as described in the embodiments of FIG. 2;
(5) a CPA procedure to no candidate SCGs is allowed to be performed during a CHO recovery procedure to a candidate MCG, e.g. indication #7 as described in the embodiments of FIG. 2;
(6) a CPC procedure to no candidate SCG is allowed to be performed during the CHO recovery procedure, e.g. indication #7 as described in the embodiments of FIG. 2;
(7) the UE accesses the candidate MCG via the CHO recovery procedure, e.g. indication #8 as described in the embodiments of FIG. 2; or
(8) an RRC configuration for the candidate SCG is released by the UE due to the CHO recovery procedure, e.g. indication #9 as described in the embodiments of FIG. 2. Specific examples are described in the embodiments of FIGS. 6-8 as below.

Details described in all other embodiments of the present application are applicable for the embodiments shown in any of FIGS. 2-4. It should be appreciated by persons skilled in the art that the sequence of the operations in any of exemplary procedures 200, 300, and 400 in FIGS. 2-4 may be changed and some of the operations in any of exemplary procedures 200-400 in FIGS. 2-4 may be eliminated or modified, without departing from the spirit and scope of the disclosure.

The following texts describe specific embodiments as shown and illustrated in FIGS. 2-4, in which a UE and network nodes (e.g. a source MN, a target MN, a candidate MN, a source SN, a target SN, and/or candidate SN(s)) perform following operations. It should be appreciated by persons skilled in the art that the sequence of the operations in any of exemplary flowcharts 700, 800, 900, and 1000 in FIGS. 5-8 may be changed and some of the operations in any of exemplary flowcharts 700-1000 in FIGS. 5-8 may be eliminated or modified, without departing from the spirit and scope of the disclosure.

FIG. 5 illustrates an exemplary flowchart of a CHO with candidate SCG mechanism in accordance with some embodiments of the present application. Details described in all other embodiments of the present application are applicable for the embodiments shown in FIG. 5.

In the exemplary flowchart 700 as shown in FIG. 5, in operation 711, UE 701 in an RRC connected state accesses its serving BS, i.e., source MN 702. For instance, DC (Dual Connectivity) may be configured for UE 701. In some embodiments, UE 701 may report measurement result(s) to source MN 702.

In operation 712, based on the measurement result(s), source MN 702 may determine to switch UE 701 to candidate MN 705 via a CHO procedure.

In operation 713, source MN 702 may transmit a handover request to candidate MN 705. For instance, source MN 702 may indicate candidate MN 705 to prepare a candidate SCG.

In operation 714, after candidate MN 705 receives the handover request from source MN 702, candidate MN 705 may transmit a request (e.g. SgNB addition request message or SN modification request message) to candidate SN 704 via Xn interface.

In operation 715, candidate SN 704 may transmit an acknowledge message (e.g. SgNB addition request acknowledge message or SgNB modification request acknowledge message) to candidate MN 705. Configuration(s) for candidate SCG(s) of candidate SN 704 may be included in the acknowledge message.

In operation 716, after receiving the acknowledge message from candidate SN 704, candidate MN 705 transmits a handover request acknowledge message including RRC configuration(s) for a candidate MCG (e.g. RRC configuration #1 as described in the embodiments of FIG. 2) and/or RRC configuration(s) for the candidate SCG(s) (e.g. RRC configuration #2 as described in the embodiments of FIG. 2) to source MN 702.

In some embodiments, the RRC configuration(s) for the candidate MCG may include CHO configuration(s) for the candidate MCG and CHO execution condition(s) for the candidate MCG. In some embodiments, the RRC configuration(s) for the candidate SCG(s) may include: (1) CPA configuration(s) and CPA execution condition(s) for the candidate SCG(s); or (2) CPC configuration(s) and a set of CPC execution conditions for the candidate SCG(s).

In operation 717, after receiving the handover request acknowledge message from candidate MN 705, source MN 702 transmits an RRC reconfiguration message including the RRC configuration(s) for the candidate MCG and/or the RRC configuration(s) for the candidate SCG(s) to UE 701.

In operation 718, after receiving the RRC reconfiguration message from source MN 702, UE 701 transmits an RRC reconfiguration complete message to source MN 702.

In operation 719, there may be different embodiments in different scenarios, i.e. Embodiment 1, Embodiment 2, and Embodiment 3 as below.

### Embodiment 1

In operation 719, UE 701 starts to “concurrently evaluate” or “sequentially evaluate” the CHO execution condition(s) for the candidate MCG and/or the execution condition(s) for the candidate SCG(s) (e.g. CPA or CPC execution condition(s)).

In some embodiments of “concurrently evaluate”, UE 701 starts to evaluate the CHO execution condition(s) for the candidate MCG upon receiving the RRC configuration(s) for the candidate MCG in the RRC reconfiguration message, and starts to evaluate the CPA or CPC execution condition(s) upon receiving the RRC configuration(s) for the candidate SCG(s) in the RRC reconfiguration message.

In some embodiments of “sequentially evaluate”, UE 701 starts to evaluate the CHO execution condition(s) for the candidate MCG when receiving the RRC configuration(s) for the candidate MCG in the RRC reconfiguration message. The UE starts to evaluate the CPA or CPC execution condition(s) upon fulfillment of the CHO execution condition(s) for the candidate MCG.

In operation 719 of Embodiment 1, there may be following two options in different embodiments, i.e., Option 1 and Option 2 as below.

Option 1: UE 701 may release the RRC configuration(s) associated with the candidate SCG(s) in response to that:
(1) the CPA or CPC execution condition(s) for each candidate SCG within the candidate SCG(s) is not fulfilled when the UE completes an RA procedure to the candidate MCG;
(2) the CPA or CPC execution condition(s) for the each candidate SCG is not fulfilled when a handover timer (e.g. timer T304) for the candidate MCG is stopped;
(3) the CPA or CPC execution condition(s) for the each candidate SCG is not fulfilled after a time period (e.g. time period #1 as described in the embodiments of FIG. 2) since the UE completes the RA procedure to the candidate MCG;
(4) the CPA or CPC execution conditions(s) for the each candidate SCG is not fulfilled when the CHO execution condition(s) for the candidate MCG is fulfilled; or
(5) the CPA or CPC execution condition(s) for the each candidate SCG is not fulfilled after a time period (e.g. time period #2 as described in the embodiments of FIG. 2) since fulfillment of the CHO execution condition(s) for the candidate MCG.

Option 2: UE 701 may stop evaluating the execution condition(s) for the candidate SCG(s) in response to that:
(1) the CPA or CPC execution condition(s) for each candidate SCG within the candidate SCG(s) is not fulfilled when the UE completes an RA procedure to the candidate MCG;
(2) the CPA or CPC execution condition(s) for the each candidate SCG is not fulfilled when a handover timer (e.g. timer T304) for the candidate MCG is stopped;
(3) the CPA or CPC execution condition(s) for the each candidate SCG is not fulfilled after a time period (e.g. time period #1 as described in the embodiments of FIG. 2) since the UE completes the RA procedure to the candidate MCG;
(4) the CPA or CPC execution conditions(s) for the each candidate SCG is not fulfilled when the CHO execution condition(s) for the candidate MCG is fulfilled; or
(5) the CPA or CPC execution condition(s) for the each candidate SCG is not fulfilled after a time period (e.g. time period #2 as described in the embodiments of FIG. 2) since fulfillment of the CHO execution condition(s) for the candidate MCG.

### Embodiment 2

In operation 719, UE 701 starts to evaluate the CHO execution condition(s) for the candidate MCG. After the CHO execution condition(s) for the candidate MCG is fulfilled, UE 701 starts to evaluate the execution condition(s) for the candidate SCG(s) (e.g. CPA or CPC execution condition(s)). In some embodiments, if the CPA or CPC execution condition(s) for a candidate SCG (e.g. candidate SCG #1 as described in the embodiments of FIG. 2) within the candidate SCG(s) is fulfilled, UE 701 may stop evaluating the CPA or CPC execution condition(s) for other candidate SCG(s) within the candidate SCG(s). In some embodiments, when the CPA or CPC execution condition(s) for the candidate SCG (e.g. candidate SCG #1) is fulfilled, UE 701 may release the RRC configuration(s) for other candidate SCG(s), e.g. including CPA or CPC configuration(s) and CPA or CPC execution condition(s) for these other candidate SCG(s).

### Embodiment 3

In operation 719, UE 701 may firstly evaluate the CPA or CPC execution condition(s) for the candidate SCG(s), and then start to evaluate the CHO execution condition(s) for the candidate MCG after the CPA or CPC execution conditions for the candidate SCG(s) is fulfilled. In Embodiment 3, only in the case that execution condition(s) for both the candidate MCG and the candidate SCG(s) are fulfilled together, CHO with candidate SCG(s) is performed (e.g. UE 701 accesses candidate MN 705 based the CHO configuration(s) for the candidate MCG and accesses candidate SN 704 based on the configuration(s) for the candidate SCG(s)). CHO with candidate SCG(s) is not applied in the case that only the CHO execution condition for the candidate MCG is fulfilled but the set of CPA or CPC execution conditions for the candidate SCG(s) is not met.

FIG. 6 illustrates a further exemplary flowchart of a CHO with candidate SCG mechanism in accordance with some embodiments of the present application. Details described in all other embodiments of the present application are applicable for the embodiments shown in FIG. 6.

In the exemplary flowchart 800 as shown in FIG. 6, in operation 811, UE 801 in an RRC connected state accesses its serving BS, i.e., source MN 802. For instance, DC (Dual Connectivity) may be configured for UE 801. In some embodiments, UE 801 may report measurement result(s) to source MN 802.

In operation 812, based on the measurement result(s), source MN 802 may determine to switch UE 801 to candidate MN 805 via a CHO procedure.

In operation 813, source MN 802 may transmit a handover request to candidate MN 805. For instance, source MN 802 may indicate candidate MN 805 to prepare a candidate SCG.

In operation 814, after candidate MN 805 receives the handover request from source MN 802, candidate MN 805 may transmit a request (e.g. SgNB addition request message or SN modification request message) to candidate SN 804 via Xn interface.

In operation 815, candidate SN 804 may transmit an acknowledge message (e.g. SgNB addition request acknowledge message or SgNB modification request acknowledge message) to candidate MN 805. Configuration(s) for candidate SCG(s) of candidate SN 804 may be included in the acknowledge message.

In operation 816, after receiving the acknowledge message from candidate SN 804, candidate MN 805 transmits a handover request acknowledge message including RRC configuration(s) associated with a candidate MCG (e.g. RRC configuration #1 as described in the embodiments of FIG. 2) and/or RRC configuration(s) for the candidate SCG(s) (e.g. RRC configuration #2 as described in the embodiments of FIG. 2) to source MN 802.

In some embodiments, the RRC configuration(s) associated with the candidate MCG may include CHO configuration(s) for the candidate MCG and CHO execution condition(s) for the candidate MCG, and may be named as “CHO configuration(s) associated with the candidate MCG” or the like. In some embodiments, the RRC configuration(s) associated with the candidate SCG(s) may include: (1) CPA configuration(s) and CPA execution condition(s) for the candidate SCG(s); or (2) CPC configuration(s) and a set of CPC execution conditions for the candidate SCG(s).

In operation 817, after receiving the handover request acknowledge message from candidate MN 805, source MN 802 transmits an RRC reconfiguration message including the CHO configuration(s) associated with the candidate MCG and/or the configuration(s) for the candidate SCG(s) to UE 801.

In operation 818, after receiving the RRC reconfiguration message from source MN 802, UE 801 transmits an RRC reconfiguration complete message to source MN 802.

In operation 819, UE 801 starts to “concurrently evaluate” or “sequentially evaluate” the CHO execution condition(s) for the candidate MCG and/or the CPA or CPC execution condition(s) for the candidate SCG(s).

In some embodiments of “concurrently evaluate”, UE 801 starts to evaluate the CHO execution condition(s) for the candidate MCG upon receiving the RRC configuration(s) for the candidate MCG in the RRC reconfiguration message, and starts to evaluate the CPA or CPC execution condition(s) upon receiving the RRC configuration(s) for the candidate SCG(s) in the RRC reconfiguration message.

In some embodiments of “sequentially evaluate”, UE 801 starts to evaluate the CHO execution condition(s) for the candidate MCG when receiving the RRC configuration(s) for the candidate MCG in the RRC reconfiguration message. The UE starts to evaluate the CPA or CPC execution condition(s) upon fulfillment of the CHO execution condition(s) for the candidate MCG.

In some embodiments, after the CHO execution condition(s) for the candidate MCG is met in operation 819, the execution condition(s) for the candidate SCG(s) can be relaxed. For instance, in operation 820, UE 801 considers the CPA or CPC execution condition(s) for the candidate SCG(s) as met in response to the following two options in different embodiments, in Option A and Option B as below.
(1) Option A: once a CPA or CPC entering condition for a candidate SCG within the candidate SCG(s) is met when timer T304 for the candidate MCG is running, UE 801 considers the CPA or CPC execution condition(s) for the candidate SCG as fulfilled.
(2) Option B: once channel quality of a PSCell of a candidate SCG within the candidate SCG(s) is greater than or equal to a configured or pre-configured threshold (e.g. when S-criteria is fulfilled) when timer T304 for the candidate MCG is running, UE 801 considers the CPA or CPC execution condition(s) for the candidate SCG as fulfilled.

In some embodiments, in operations 821A and 821B, after UE 801 considers that the CPA or CPC execution condition(s) for the candidate SCG(s) are met, UE 801 accesses candidate MN 805 based on the CHO configuration(s) for the candidate MCG and accesses candidate SN 804 based on the CPA or CPC configuration(s) for the candidate SCG(s) in the RRC reconfiguration message received in operation 817. The sequences of operations 821A and 821B are not fixed and may be varied in different embodiments.

In some other embodiments, operation 821B is performed prior to operation 820. That is, in operation 821B, UE 801 accesses candidate MN 805 based on the CHO configuration(s) for the candidate MCG after the CHO execution condition(s) for the candidate MCG is met in operation 819. Then, in operation 821A, UE 801 accesses candidate SN 804 based on the CPA or CPC configuration(s) for the candidate SCG(s) after UE 801 considers that the CPA or CPC execution condition(s) for the candidate SCG(s) are met in operation 820.

In operation 822, UE 801 transmits an RRC reconfiguration complete message to candidate MN 805. In some embodiments, the RRC reconfiguration complete message includes an SN RRC reconfiguration complete message. In an embodiment, which candidate SCG among multiple candidate SCGs should be indicated in the SN RRC reconfiguration complete message for candidate SN 804. For instance, the SN RRC reconfiguration complete message includes an ID of the candidate SCG belonging to candidate SN 804.

In some embodiments, the RRC reconfiguration complete message in operation 822 includes at least one of following indications. In an embodiment, at least one of following indications is included in the SN RRC reconfiguration complete message which is embodied in the RRC reconfiguration complete message.
(1) an indication (e.g. indication #1) to indicate that a candidate SCG (e.g. candidate SCG #1) associated with candidate SN 804 is selected for cell addition;
(2) an indication (e.g. indication #2) to indicate that the candidate SCG (e.g. candidate SCG #1) associated with candidate SN 804 is selected for cell switching;
(3) an indication (e.g. indication #3) to indicate a subset of candidate SCG(s) not selected from all candidate SCG(s) for cell addition; or
(4) an indication (e.g. indication #4) to indicate a subset of candidate SCG(s) not selected from all candidate SCG(s) for cell switching.

In some embodiments, in operation 823A, candidate MN 805 transmits the SN RRC reconfiguration complete message as well as indication #1 or indication #2 to candidate SN 804. In an embodiment, indication #1 or indication #2 is included in the SN RRC reconfiguration complete message. In another embodiment, indication #1 or indication #2 is included in another RRC message to candidate SN 804 via Xn interface.

In operation 823B (optional), candidate MN 805 transmits indication #3 and/or indication #4 to candidate SN(s) 806, e.g. in an RRC message via Xn interface, to indicate to candidate SN(s) which is not selected for cell addition or cell switching. Then, candidate SN(s) 806 may release or cancel the reserved resource(s) for UE 801.

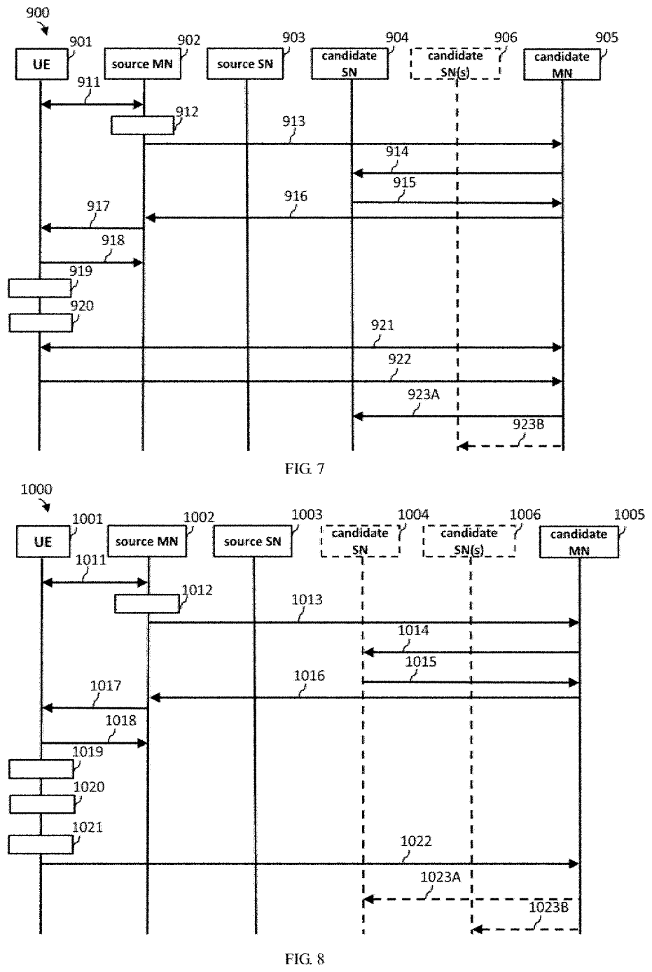

FIG. 7 illustrates another exemplary flowchart of a CHO with candidate SCG mechanism in accordance with some embodiments of the present application. Details described in all other embodiments of the present application are applicable for the embodiments shown in FIG. 7.

In the exemplary flowchart 900 as shown in FIG. 7, in operation 911, UE 901 in an RRC connected state accesses its serving BS, i.e., source MN 902. For instance, DC (Dual Connectivity) may be configured for UE 901. In some embodiments, UE 901 may report measurement result(s) to source MN 902.

In operation 912, based on the measurement result(s), source MN 902 may determine to switch UE 901 to candidate MN 905 via a CHO procedure.

In operation 913, source MN 902 may transmit a handover request to candidate MN 905. For instance, source MN 902 may indicate candidate MN 905 to prepare a candidate SCG.

In operation 914, after candidate MN 905 receives the handover request from source MN 902, candidate MN 905 may transmit a request (e.g. SgNB addition request message or SN modification request message) to candidate SN 904 via Xn interface.

In operation 915, candidate SN 904 may transmit an acknowledge message (e.g. SgNB addition request acknowledge message or SgNB modification request acknowledge message) to candidate MN 905. Configuration(s) for candidate SCG(s) of candidate SN 904 may be included in the acknowledge message.

In operation 916, after receiving the acknowledge message from candidate SN 904, candidate MN 905 transmits a handover request acknowledge message including RRC configuration(s) associated with a candidate MCG (e.g. RRC configuration #1 as described in the embodiments of FIG. 2) and/or RRC configuration(s) for the candidate SCG(s) (e.g. RRC configuration #2 as described in the embodiments of FIG. 2) to source MN 902.

In some embodiments, the RRC configuration(s) associated with the candidate MCG may include CHO configuration(s) for the candidate MCG and CHO execution condition(s) for the candidate MCG, and may be named as “CHO configuration(s) associated with the candidate MCG” or the like. In some embodiments, the RRC configuration(s) associated with the candidate SCG(s) may include: (1) CPA configuration(s) and CPA execution condition(s) for the candidate SCG(s); or (2) CPC configuration(s) and a set of CPC execution conditions for the candidate SCG(s).

In operation 917, after receiving the handover request acknowledge message from candidate MN 905, source MN 902 transmits an RRC reconfiguration message including the CHO configuration(s) associated with the candidate MCG and/or the configuration(s) for the candidate SCG(s) to UE 901.

In operation 918, after receiving the RRC reconfiguration message from source MN 902, UE 901 transmits an RRC reconfiguration complete message to source MN 902.

In operation 919, UE 901 starts to “concurrently evaluate” or “sequentially evaluate” the CHO execution condition(s) for the candidate MCG and/or the CPA or CPC execution condition(s) for the candidate SCG(s).

In some embodiments of “concurrently evaluate”, UE 901 starts to evaluate the CHO execution condition(s) for the candidate MCG upon receiving the RRC configuration(s) for the candidate MCG in the RRC reconfiguration message, and starts to evaluate the CPA or CPC execution condition(s) upon receiving the RRC configuration(s) for the candidate SCG(s) in the RRC reconfiguration message.

In some embodiments of “sequentially evaluate”, UE 901 starts to evaluate the CHO execution condition(s) for the candidate MCG when receiving the RRC configuration(s) for the candidate MCG in the RRC reconfiguration message. The UE starts to evaluate the CPA or CPC execution condition(s) upon fulfillment of the CHO execution condition(s) for the candidate MCG.

In some embodiments, in operation 920, the CPA or CPC execution condition(s) for all candidate SCG(s) are not met. In operation 921, UE 901 accesses candidate MN 905 based on the CHO configuration(s) for the candidate MCG in the RRC reconfiguration message received in operation 917.

The sequences of operations 920 and 921 are not fixed and may be varied in different embodiments. In some other embodiments, operation 921 is performed prior to operation 920. That is, in operation 921, UE 901 accesses candidate MN 905 based on the CHO configuration(s) for the candidate MCG after the CHO execution condition(s) for the candidate MCG is met in operation 919. Then, UE 901 determines that the CPA or CPC execution condition(s) for the candidate SCG(s) are not met in operation 920.

In some embodiments, in operation 922, UE 901 transmits an RRC reconfiguration complete message to candidate MN 905. For instance, the RRC reconfiguration complete message includes at least one of following indications. In some other embodiments, at least one of following indications are included in an RRC message to candidate MN 905 via Xn interface which may be transmitted in operation 922.
(1) an indication (e.g. indication #5) to indicate that no candidate SCG within the candidate SCG(s) is selected for cell addition; or
(2) an indication (e.g. indication #6) to indicate that no candidate SCG within the candidate SCG(s) is selected for cell switching.

In some embodiments, in operation 923A, candidate MN 905 transmits indication #5 and/or indication #6 to candidate SN 904, e.g. in an RRC message via Xn interface, to indicate to candidate SN 904 that no candidate SCG is added for cell addition or cell switching. Then, candidate SN 904 may release or cancel the reserved resource(s) for UE 901.

In operation 923B (optional), candidate MN 905 transmits indication #5 and/or indication #6 to candidate SN(s) 906, e.g. in an RRC message via Xn interface, to indicate to candidate SN(s) that no candidate SCG is added for cell addition or cell switching. Then, candidate SN(s) 906 may release or cancel the reserved resource(s) for UE 901.

FIG. 8 illustrates another exemplary flowchart of a CHO with candidate SCG mechanism in accordance with some embodiments of the present application. Details described in all other embodiments of the present application are applicable for the embodiments shown in FIG. 8.

In the exemplary flowchart 1000 as shown in FIG. 8, in operation 1011, UE 1001 in an RRC connected state accesses its serving BS, i.e., source MN 1002. For instance, DC (Dual Connectivity) may be configured for UE 1001. In some embodiments, UE 1001 may report measurement result(s) to source MN 1002.

In operation 1012, based on the measurement result(s), source MN 1002 may determine to switch UE 1001 to candidate MN 1005 via a CHO procedure.

In operation 1013, source MN 1002 may transmit a handover request to candidate MN 1005. For instance, source MN 1002 may indicate candidate MN 1005 to prepare a candidate SCG.

In operation 1014, after candidate MN 1005 receives the handover request from source MN 1002, candidate MN 1005 may transmit a request (e.g. SgNB addition request message or SN modification request message) to candidate SN 1004 via Xn interface.

In operation 1015, candidate SN 1004 may transmit an acknowledge message (e.g. SgNB addition request acknowledge message or SgNB modification request acknowledge message) to candidate MN 1005. Configuration(s) for candidate SCG(s) of candidate SN 1004 may be included in the acknowledge message.

In operation 1016, after receiving the acknowledge message from candidate SN 1004, candidate MN 1005 transmits a handover request acknowledge message including RRC configuration(s) associated with a candidate MCG (e.g. RRC configuration #1 as described in the embodiments of FIG. 2) and/or RRC configuration(s) for the candidate SCG(s) (e.g. RRC configuration #2 as described in the embodiments of FIG. 2) to source MN 1002.

In some embodiments, the RRC configuration(s) associated with the candidate MCG may include CHO configuration(s) for the candidate MCG and CHO execution condition(s) for the candidate MCG, and may be named as “CHO configuration(s) associated with the candidate MCG” or the like. In an embodiment, the RRC configuration(s) associated with the candidate MCG includes the attemptCondReconfig IE, which is configured to indicate whether a CHO recovery is allowed to be performed or not. If the attemptCondReconfig IE is configured, this IE may also imply that CHO with candidate SCG is allowed. For example, the IE indicates that a CPA procedure or a CPC procedure to one or more candidate SCGs is allowed to be performed during the CHO recovery procedure.

In some embodiments, the RRC configuration(s) associated with the candidate SCG(s) may include: (1) CPA configuration(s) and CPA execution condition(s) for the candidate SCG(s); or (2) CPC configuration(s) and a set of CPC execution conditions for the candidate SCG(s).

In operation 1017, after receiving the handover request acknowledge message from candidate MN 1005, source MN 1002 transmits an RRC reconfiguration message including the CHO configuration(s) associated with the candidate MCG and/or the configuration(s) for the candidate SCG(s) to UE 1001.

In operation 1018, after receiving the RRC reconfiguration message from source MN 1002, UE 1001 transmits an RRC reconfiguration complete message to source MN 1002.

In operation 1019, UE 1001 starts to “concurrently evaluate” or “sequentially evaluate” the CHO execution condition(s) for the candidate MCG and/or the CPA or CPC execution condition(s) for the candidate SCG(s).

In some embodiments of “concurrently evaluate”, UE 1001 starts to evaluate the CHO execution condition(s) for the candidate MCG upon receiving the RRC configuration(s) for the candidate MCG in the RRC reconfiguration message, and starts to evaluate the CPA or CPC execution condition(s) upon receiving the RRC configuration(s) for the candidate SCG(s) in the RRC reconfiguration message.

In some embodiments of “sequentially evaluate”, UE 1001 starts to evaluate the CHO execution condition(s) for the candidate MCG when receiving the RRC configuration(s) for the candidate MCG in the RRC reconfiguration message. The UE starts to evaluate the CPA or CPC execution condition(s) upon fulfillment of the CHO execution condition(s) for the candidate MCG.

In operation 1020, a failure happens, e.g. an RLF on the source MCG associated with source MN 1002, a failure of handover, or a failure of CHO. In some embodiments, if the attemptCondReconfig IE is configured in the RRC configuration(s) associated with the candidate MCG in operation 1017, after the failure happens, UE 1001 initiates an RRC re-establishment procedure in operation 1020.

In operation 1021, UE 1001 selects a candidate cell among CHO candidate PCell(s). Then, UE 1001 may perform a CHO procedure to the selected candidate cell. That is, UE 1001 performs a CHO recovery procedure in operation 1021.

Then, there may be following two options in different embodiments, i.e., Option M, Option N, and Option L as below.

Option M: If the channel quality of a PSCell of a candidate SCG (e.g. candidate SN 1004) within the candidate SCG(s) is greater than a threshold (e.g. S-criteria is met for the candidate PSCell), UE 1001 may perform a CPA or CPC procedure associated with the candidate SCG together with the CHO recovery procedure in operation 1021. Then, UE 1001 may transmit an RRC reconfiguration complete message to candidate MN 1005.

Option N: a CPA or CPC procedure associated with the candidate SCG is not performed when the CHO recovery procedure is performed in operation 1021. In particular, after UE 1001 performs a CHO recovery procedure in operation 1021, operations 1022, 1023A, 1023B may be performed.
(1) In operation 1022, UE 1001 transmits at least one of following indications to candidate MN 1005, e.g. in an RRC message via Xn interface or an RRC reconfiguration complete message. In some embodiments, candidate MN 1005 may perform bearer re-mapping to candidate SCG(s) based on the RRC message or the RRC reconfiguration complete message in operation 1022.
   (a) An indication (e.g. indication #7) to indicate that a CPA procedure or a CPC procedure to no candidate SCG is allowed to be performed during a CHO recovery procedure.
   (b) An indication (e.g. indication #8) to indicate the CHO recovery procedure.
   (c) An indication (e.g. indication #9) to indicate RRC configuration for the candidate SCG(s) is released due to the CHO recovery procedure.
(2) In operation 1023A (optional), candidate MN 1005 transmits indication #7, indication #8, and/or indication #9 to candidate SN 1004, e.g. in an RRC message via Xn interface, to indicate to candidate SN 1004 that no candidate SCG is added for cell addition or cell switching. Then, candidate SN 1004 may release or cancel the reserved resource(s) for UE 1001.
(3) In operation 1023B (optional), candidate MN 1005 transmits indication #7, indication #8, and/or indication #9 to candidate SN(s) 1006, e.g. in an RRC message via Xn interface, to indicate to candidate SN(s) that no candidate SCG is added for cell addition or cell switching. Then, candidate SN(s) 1006 may release or cancel the reserved resource(s) for UE 1001.

Details described in all other embodiments of the present disclosure are applicable for the embodiments shown in any of FIGS. 5-8. It should be appreciated by persons skilled in the art that the sequence of the operations in any of exemplary procedures 700-1000 in FIGS. 5-8 may be changed and some of the operations in any of exemplary procedures 700-1000 in FIGS. 5-8 may be eliminated or modified, without departing from the spirit and scope of the disclosure.

FIG. 9 illustrates a block diagram of an exemplary apparatus 1100 in accordance with some embodiments of the present disclosure. As shown in FIG. 9, the apparatus 1100 may include at least one processor 1106 and at least one transceiver 1102 coupled to the processor 1106.

Although in this figure, elements such as the at least one transceiver 1102 and processor 1106 are described in the singular, the plural is contemplated unless a limitation to the singular is explicitly stated. In some embodiments of the present application, the transceiver 1102 may be divided into two devices, such as a receiving circuitry and a transmitting circuitry. In some embodiments of the present application, the apparatus 1100 may further include an input device, a memory, and/or other components.

In some embodiments of the present application, the apparatus 1100 may be a UE, a target MN, a candidate MN, a source MN, a target SN, a candidate SN, or a source SN. The transceiver 1102 and the processor 1106 may interact with each other so as to perform the operations with respect to the UE, the target MN, the candidate MN, the source MN, the target SN, the candidate SN, or the source SN described above, for example, in any of FIGS. 1-8.

In some embodiments of the present application, the apparatus 1100 may further include at least one non-transitory computer-readable medium. For example, in some embodiments of the present disclosure, the non-transitory computer-readable medium may have stored thereon computer-executable instructions to cause the processor 1106 to implement the method with respect to the UEs as described above. For example, the computer-executable instructions, when executed, cause the processor 1106 interacting with transceiver 1102 to perform the operations with respect to the UE, the target MN, the candidate MN, the source MN, the target SN, the candidate SN, or the source SN described in FIGS. 1-8.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive a first radio resource control (RRC) configuration and a second RRC configuration, wherein the first RRC configuration includes conditional handover (CHO) configuration information and a CHO execution condition for a candidate master cell group (MCG), and the second RRC configuration includes configuration information for one or more candidate secondary cell groups (SCGs) and a set of execution conditions for the one or more candidate SCGs; and
evaluate the CHO execution condition for the candidate MCG upon reception of the first RRC configuration.

2. The UE of claim 1, wherein the first RRC configuration and the second RRC configuration are received via separate messages or via a same message.

3. The UE of claim 1, wherein the configuration information for the one or more candidate SCGs and the set of execution conditions for the one or more candidate SCGs include:
conditional primary secondary cell group (PSCell) addition (CPA) configuration information and the set of CPA execution conditions for the one or more candidate SCGs; or
conditional PSCell change (CPC) configuration information and a set of CPC execution conditions for the one or more candidate SCGs.

4. The UE of claim 3, wherein the at least one processor is further configured to cause the UE to:
evaluate the set of CPA execution conditions upon reception of the second RRC configuration for CPA; or
evaluate the set of CPC execution conditions upon reception of the second RRC configuration for CPC.

5. The UE of claim 3, wherein the at least one processor is further configured to cause the UE to:
start to evaluate the set of CPA execution conditions in response to fulfillment of the CHO execution condition for the candidate MCG; or
start to evaluate the set of CPC execution conditions in response to the fulfillment of the CHO execution condition for the candidate MCG.

6. The UE of claim 5, wherein the at least one processor is further configured to cause the UE to:
stop evaluation of the set of CPA execution conditions for other one or more candidate SCGs within the one or more candidate SCGs in response to fulfillment of the set of CPA execution condition for one candidate SCG within the one or more candidate SCGs; or
stop evaluation of the set of CPC execution conditions for other one or more candidate SCGs within the one or more candidate SCGs in response to fulfillment of the set of CPC execution conditions for one candidate SCG within the one or more candidate SCGs.

7. The UE of claim 1, wherein the at least one processor is configured to cause the UE to release the second RRC configuration in response to:
the set of execution conditions for each candidate SCG within the one or more candidate SCGs is not fulfilled when the UE completes a random access (RA) procedure to the candidate MCG;
the set of execution conditions for the each candidate SCG is not fulfilled when a handover timer for the candidate MCG is stopped;
the set of execution conditions for the each candidate SCG is not fulfilled after a first time period since the UE completes the RA procedure to the candidate MCG;
the set of execution conditions for the each candidate SCG is not fulfilled when the CHO execution condition for the candidate MCG is fulfilled; or
the set of execution conditions for the each candidate SCG is not fulfilled after a second time period since fulfillment of the CHO execution condition for the candidate MCG.

8. The UE of claim 1, wherein in response to fulfillment of the CHO execution condition for the candidate MCG, the at least one processor is further configured to cause the UE to stop evaluation of the set of execution conditions for the one or more candidate SCGs in response to:
the set of execution conditions for each candidate SCG within the one or more candidate SCGs is not fulfilled when the UE completes a random access (RA) procedure to the candidate MCG;
the set of execution conditions for the each candidate SCG is not fulfilled when a handover timer for the candidate MCG is stopped;
the set of execution conditions for the each candidate SCG is not fulfilled after a first time period since the UE completes the RA procedure to the candidate MCG;
the set of execution conditions for the each candidate SCG is not fulfilled when the CHO execution condition for the candidate MCG is fulfilled; or
the set of execution conditions for the each candidate SCG is not fulfilled after a second time period since the fulfillment of the CHO execution condition for the candidate MCG.

9. The UE of claim 8, wherein the at least one processor is further configured to cause the UE to release the set of execution conditions for the one or more candidate SCGs after evaluation of the set of execution conditions for the one or more candidate SCGs has stopped.

10. The UE of claim 1, wherein in response to fulfillment of the CHO execution condition for the candidate MCG, the at least one processor is configured to cause the UE to:
perform a random access (RA) procedure to the candidate MCG based at least in part on the first RRC configuration; and
transmit an RRC reconfiguration complete message to a candidate MN associated with the candidate MCG.

11. A candidate master node (MN), comprising:
at least one memory; and
at least one processor coupled with the at least one memory and configured to cause the MN to:
receive a radio resource control (RRC) reconfiguration complete message; and
transmit an indication associated with a candidate secondary cell group (SCG).

12. The candidate MN of claim 11, wherein the indication indicates at least one of:
the candidate SCG is selected for cell addition;
the candidate SCG is selected for cell switching;
the candidate SCG is not selected for cell addition;
the candidate SCG is not selected for cell switching;
no candidate SCG is selected for cell addition;
no candidate SCG is selected for cell switching;
a conditional primary secondary cell group (PSCell) addition (CPA) procedure to no candidate SCGs is allowed to be performed during a conditional handover (CHO) recovery procedure to a candidate master cell group (MCG);
a conditional PSCell change (CPC) procedure to no candidate SCG is allowed to be performed during the CHO recovery procedure;
a user equipment (UE) accesses the candidate MCG via a CHO procedure;
the UE accesses the candidate MCG via the CHO recovery procedure; or
an RRC configuration for the candidate SCG is released by the UE due to the CHO recovery procedure.

13. A candidate secondary node (SN), comprising:
at least one memory; and
at least one processor coupled with the at least one memory and configured to cause the SN to:
transmit a radio resource control (RRC) configuration including configuration information for a candidate secondary cell group (SCG) and a set of execution conditions for the candidate SCG; and
receive an indication associated with the candidate SCG.

14. The candidate SN of claim 13, wherein the configuration information for the candidate SCG and the set of execution conditions for the candidate SCG include:
conditional primary secondary cell group (PSCell) addition (CPA) configuration information and a set of CPA execution conditions for the candidate SCG; or
conditional PSCell change (CPC) configuration information and a set of CPC execution conditions for the candidate SCG.

15. (canceled)

16. The UE of claim 1, wherein the at least one processor is further configured to cause the UE to:
perform CHO with the one or more SCGs based at least in part on fulfillment of both the CHO execution condition for the candidate MCG and the set of execution conditions for the one or more candidate SCGs.

17. The UE of claim 1, wherein the at least one processor is further configured to cause the UE to:
transmit, based at least in part on fulfillment of a set of primary secondary cell group (PSCell) addition (CPA) execution conditions for one candidate SCG of the one or more SCGs and completion of a random access (RA) procedure to the candidate MCG, a first indication that indicates that the one candidate SCG is selected for cell addition; or
transmit, based at least in part on fulfillment of a set of conditional PSCell change (CPC) execution conditions for the one candidate SCG and completion of the RA procedure to the candidate MCG, a second indication that indicates that the one candidate SCG is selected for cell switching.

18. The MN of claim 11, wherein the at least one processor is further configured to cause the MN to:
receive, based at least in part on fulfillment of a set of primary secondary cell group (PSCell) addition (CPA) execution conditions for one candidate SCG and completion of a random access (RA) procedure to a candidate master cell group (MCG), a first indication that indicates that the one candidate SCG is selected for cell addition; or
receive, based at least in part on fulfillment of a set of conditional PSCell change (CPC) execution conditions for the one candidate SCG and completion of the RA procedure to the candidate MCG, a second indication that indicates that the one candidate SCG is selected for cell switching.

19. A method performed by a user equipment (UE), the method comprising:
receiving a first radio resource control (RRC) configuration and a second RRC configuration, wherein the first RRC configuration includes conditional handover (CHO) configuration information and a CHO execution condition for a candidate master cell group (MCG), and the second RRC configuration includes configuration information for one or more candidate secondary cell groups (SCGs) and a set of execution conditions for the one or more candidate SCGs; and
evaluating the CHO execution condition for the candidate MCG upon reception of the first RRC configuration.

20. The method of claim 19, further comprising:
performing CHO with the one or more SCGs based at least in part on fulfillment of both the CHO execution condition for the candidate MCG and the set of execution conditions for the one or more candidate SCGs.

21. The method of claim 19, further comprising:
transmitting, based at least in part on fulfillment of a set of primary secondary cell group (PSCell) addition (CPA) execution conditions for one candidate SCG of the one or more SCGs and completion of a random access (RA) procedure to the candidate MCG, a first indication that indicates that the one candidate SCG is selected for cell addition; or
transmitting, based at least in part on fulfillment of a set of conditional PSCell change (CPC) execution conditions for the one candidate SCG and completion of the RA procedure to the candidate MCG, a second indication that indicates that the one candidate SCG is selected for cell switching.
